(19) United States
(12) Patent Application Publication
(10) Pub. No.: US 2025/0057728 A1
(43) Pub. Date: Feb. 20, 2025

(54) SUPPORTED DRUG FORMULATIONS SHOWING CONTROLLED DRUG RELEASE, AND A METHOD FOR THEIR PREPARATION

(71) Applicant: Morgan State University, Baltimore, MD (US)

(72) Inventor: Alexandr Samokhvalov, Baltimore, MD (US)

(21) Appl. No.: 18/806,301

(22) Filed: Aug. 15, 2024

Related U.S. Application Data
(60) Provisional application No. 63/533,506, filed on Aug. 18, 2023.

(51) Int. Cl. A61J 3/02

(52) U.S. Cl. CPC A61J 3/02

(57) ABSTRACT

A method for preparing pharmaceutical compositions and compositions made thereby for delayed or accelerated drug release, the method including pre-mixing a powdered drug with a powdered support material without grinding element or grinding fluid, adding grinding fluid and grinding element, co-grinding the resulting wetted mixture, and drying the obtained ground wetted mixture to produce a final product, where the support material is preferably metal-organic framework.

### GOVERNMENT RIGHTS

This invention was made with government support under grant number NIH SC3GM136647 and NIH UL1GM118973, awarded by the National Institutes of Health. The government has certain rights in the invention.

### FIELD OF THE INVENTION

The present invention relates to the field of pharmacology and medicine, and specifically to supported medicinal drug formulations that exhibit delayed or accelerated release characteristics.

### DESCRIPTION OF THE BACKGROUND

It has been a widespread practice in the pharmaceutical field to grind powder of a medicinal drug in order to decrease the size of particles and increase surface area. The resultant useful outcome is faster dissolution of the drug.

In addition to this general method, various techniques of grinding have been applied to mixtures of drug and specially selected support materials. This procedure is commonly denoted as co-grinding, the primary goal of which is to achieve faster dissolution rate of the drug from the co-ground drug/support material mixture or composition.

Often, it is desired not to immediately accelerate the rate of drug release, but to have drug release occurring during a certain specific time interval. Pharmaceutical compositions for oral administration in the form of powders or beads can be prepared, which show delayed or controlled-release performance.

To prepare drug/support material compositions by co-grinding, the technique is based on the two basic elements: 1) the use of mills and their components as grinding tool (of single ball type, multi-ball type, mortar type, and others) in which the impact or friction energy between the grinding tool and the powder is very high. Grinding/milling leads to a decrease of size of crystals of drugs, increase of surface area, and their faster dissolution; and 2) the use of support materials which facilitate the desired transformations of the drug. These processes can be denoted as dry co-grinding.

In the early studies of dry co-grinding, natural organic polymers were used as the support materials. U.S. Pat. No. 3,966,899 describes mixing pharmaceutical drugs with beta-1,4-glucan and pulverizing the mixture. This method yields composite materials with a plurality of drugs, wherein each drug is released at the same uniform rate.

Further, for dry co-grinding with drugs, synthetic organic polymers have been used. U.S. Pat. No. 4,639,370 describes the use of dry co-grinding of synthetic polymers, such as cross-linked polyvinylpyrrollidone, with the drugs.

In the above patents, dry co-grinding of powders of drug and support material is conducted to achieve an improved drug dissolution (faster dissolution rate). These characteristics are desired for the systemic drug administration: either intravenous or oral.

In medicinal practice, it is often desired to achieve delayed drug release. This principle is utilized in drug-eluting devices, e.g., implants, patches, etc., with time-delayed release. Drug-eluting devices contain compositions of drug and support material. Delayed drug release eliminates or minimizes adverse effects of the “burst” and offers time-delayed and sustained drug release.

Metal-organic frameworks (MOFs) are hybrid organic-inorganic coordination polymers that exist in the form of powder. MOFs contain cations of metals (inorganic part) and linkers (organic part). Over a decade ago, MOFs were shown to be suitable support materials for preparation of compositions containing specific drugs, which feature delayed drug release.

There are no patents on preparation of compositions of MOFs with medicinal drugs which are prepared by co-grinding powders, and where the obtained compositions show accelerated or delayed drug release.

Further, the process of grinding and co-grinding powders can utilize mechano-chemistry with an additional impact. The mechano-chemical process of grinding powders in the presence of a specially selected grinding fluid is referred to as liquid-assisted grinding, LAG or liquid-assisted milling.

Importantly, mechano-chemical processes are conducted with powders where particle sizes range from a few millimeters to micrometers, or with nanoparticles. Mixtures of powders have high heterogeneity, and their mixing can be very non-uniform during the mechano-chemical process.

### SUMMARY OF THE INVENTION

In view of the aforementioned deficiencies and disadvantages of the prior art, it is therefore desirable to improve the uniformity of mixture of powders. The present invention presents an improved formulation process which includes using the mechano-chemical process (with grinding) and an additional process of pre-mixing (without grinding).

Specifically, the inventor has discovered a process for preparing compositions of supported medicinal drugs, which is based on co-grinding the active ingredient with a pharmacologically inactive support material, which is selected from polymers and preferably, from “unconventional” synthetic hybrid organic-inorganic polymers metal-organic frameworks (MOFs). This process is characterized in that:
a) the pharmaceutically active ingredient and the inactive support material, both in the form of powders, are mixed;
b) this mixture of powders is preferably mechanically pre-mixed before any grinding element is added, meaning that it is shaken in the grinding vessel, but without any grinding element (such as steel grinding balls), to improve the uniformity of mixture;
c) the suitable fluid (“grinding fluid”) is added to the mixture of powders;
d) the grinding element is added to the mixture of powders;
e) the obtained wetted mixture is co-ground in a mill, preferably in a ball mill;
f) on completion of the wet co-grinding process, the resulting wet product is dried to remove grinding fluid, preferably under vacuum.

Specifically, the use of an additional step of mechanical pre-mixing powders of drug and support material before their liquid-assisted grinding to prepare pharmaceutical compositions has not been previously disclosed or suggested for preparation of compositions for delayed drug release; the use of liquid-assisted grinding to prepare compositions of drug and support material has not been previously disclosed or suggested for achieving delayed drug release, and the use of liquid-assisted grinding to prepare compositions of medicinal drugs and synthetic hybrid organic-inorganic polymers MOFs as the support material has not been previously disclosed or suggested for the preparation of compositions with delayed drug release.

Accordingly, there is presented according to the invention compositions of supported medicinal drugs, and methods of preparation of such compositions, using liquid-assisted co-grinding with support materials in a mechano-chemical process, to achieve delayed or accelerated drug release from the resulting compositions.

Compositions obtained by this process, according to the present invention, are characterized by delayed release of medicinal drug, or by accelerated release of medicinal drug.

### BRIEF DESCRIPTION OF THE DRAWINGS

FIG. 1 is a color photograph of poor mixing obtained by LAG of a mixture of MOF DUT-4 support material and 6-thioguanine (6-TG) in the grinding vessel of mechanical ball mill model MM 301 from Retsch. In the LAG, the grinding fluid is isopropanol, and the grinding element is one stainless steel ball.

FIG. 2 is a color photograph of a uniform mixing obtained by LAG of the mixture of MOF DUT-4 support material and 6-thioguanine (6-TG) in the grinding vessel of mechanical ball mill model MM 301 from Retsch. In the LAG, the grinding fluid is isopropanol and the grinding element is one stainless steel ball. Additionally, prior to LAG, the mixture of powders was pre-mixed in the same grinding vessel by the same mechanical ball mill, but without a grinding ball.

FIG. 3 is a drug release profile to PBS at 37° C. for 6-TG from composition “6-TG/DUT-4” prepared by LAG with pre-mixing. a) Fast dissolution of non-bonded 6-TG. b) Delayed release of bonded 6-TG.

FIG. 4 is a drug release profile for intact (not grinded) 6-TG in PBS at 37° C. a) Full time scale with concentration of drug quickly achieving a plateau. b) Early time period with fast drug dissolution.

FIG. 5 is a drug release (dissolution) profile for 6-TG, which has been processed by LAG, in PBS at 37° C. a) Full time scale with concentration of drug quickly achieving a plateau. b) Early time with fast drug dissolution.

FIG. 6 is a drug release profile to PBS at 37° C. for gemcitabine (Gem). a) Fast dissolution of pure Gem. b) Delayed release of bonded Gem from composition “Gem/Al-MOF-TCPPH₂” prepared by LAG with pre-mixing.

### DETAILED DESCRIPTION OF THE PREFERRED EMBODIMENT

In a first non-limiting example according to the invention, a pharmaceutical composition using the drug 6-TG was prepared. It is emphasized that the selection of 6-TG for this example was made due to its ready availability. The use of 6-TG for this example is not intended to limit the invention to the preparation of any particular drug, as it is envisioned that the method of the invention may be used to prepare a pharmaceutical composition with any drug or active ingredient.

### Example 1. Preparation of a Pharmaceutical Composition of 6-TG with DUT-4

DUT-4 support material prepared according to Senkovska, F., et al., New highly porous aluminium based metal-organic frameworks: Al(OH)(ndc) (ndc=2,6-naphthalene dicarboxylate) and AlOH)(bpdc) (bpdc=4,4′-biphenyl dicarboxylate), Microporous Mesoporous Mater. 122 (2009) 93-98, was thermally treated at 190° C. for 4 hours under vacuum of rotary vane oil pump to remove impurities and “activate” it, which means preparing DUT-4 for the interaction with 6-TG drug. Then, working in a glove bag filled with dried air, 1 mmol (167 mg) 6-TG and 1 mmol (258 mg) activated DUT-4 were added to a 5 ml stainless steel grinding vessel for pre-mixing. The vessel was closed tightly with a stainless-steel cap, and this assembly was placed into mechanical ball mill Retsch MM 301 and shaken at 30 Hz frequency for 30 min in a pre-mixing step.

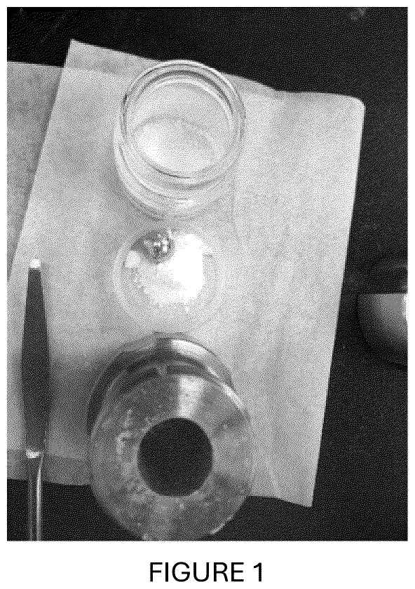

FIG. 1 shows the composition prepared by LAG processing of mixture of powders of 6-TG and MOF DUT-4 using a mechanical ball mill model MM 301 from Retsch, but without first conducting a prior pre-mixing step. The yellow material is MOF DUT-4, which was poorly mixed with 6-TG. The white material is drug 6-TG, which was in turn poorly mixed with 6-TG. Therefore, no mixing of powders of drug and support material was achieved after the LAG procedure alone.

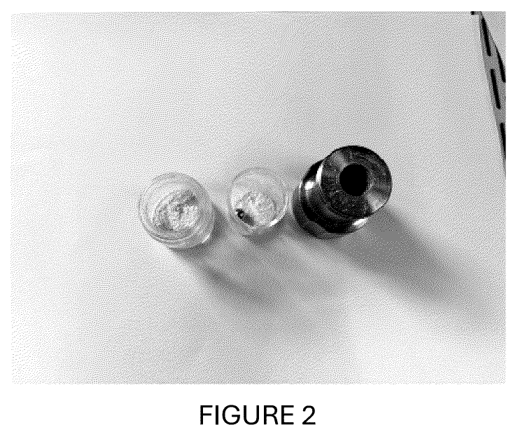

FIG. 2 shows the color photograph of good mixing obtained by LAG of the mixture of support material (MOF DUT-4) and drug 6-thioguanine (6-TG) in the grinding vessel of mechanical ball mill model MM 301 from Retsch. Here, prior to the LAG, the mixture of powders was pre-mixed in the same grinding vessel, but without a grinding ball. In the subsequent LAG of the pre-mixed specimen, grinding fluid is isopropanol and grinding element is one stainless steel ball. The mixture obtained after pre-mixing and LAG was of uniform appearance and therefore was processed further as below and tested in drug release.

Namely, after mechanical pre-mixing, the grinding vessel was opened in a glove bag filled with dried air, and 0.25 ml of isopropanol (grinding fluid) was added to the obtained dry mixture of powders. Then a grinding element (one stainless steel ball 7 mm in diameter) was added, and the grinding vessel was closed with the cap.

After this, the obtained wetted mixture of powders was grinded (LAG procedure) in a mechanical ball mill model Retsch MM 301 at a frequency of 30 Hertz. The LAG procedure was conducted by the repeating sequences “grind-idle” where “grind” means grinding time and “idle” means time of not grinding (5 min. grind+5 min. idle), and this sequence was repeated so that the total grinding time was 1 hour, and the total time of the procedure was 2 hours.

After the LAG procedure, the grinding vessel with the obtained wet LAG mixture was opened and outgassed to remove LAG fluid from the composition. For this, the opened grinding vessel with wet LAG mixture was placed into a vacuum desiccator connected to a diaphragm pump overnight.

After obtaining the dried composition, the sample of composition in the form of powder was tested for delayed release of 6-TG to phosphate buffered saline (PBS). For this, an automatic dissolution apparatus model Varian Vankel VK7000 was used, which is equipped with heater circulator model Varian Vankel VK750D, peristaltic pump, and an autosampler model VK8000. The dissolution vessel of 1 Liter in volume was filled with 750 mL PBS, maintained at 37° C. and stirred by paddle at a speed of 200 rounds per minute (RPM). After the dissolution apparatus was prepared as above, the specimen of the composition corresponding to 39 mg of 6-TG was promptly added to the dissolution vessel with PBS, and a test of delayed drug release was conducted.

In the dissolution (delayed release) test, periodically a small aliquot of 2 mL fluid from the dissolution vessel was withdrawn by an autosampler. Then, the collected aliquots were frozen for the subsequent HPLC analysis.

Finally, frozen aliquots of the sampled PBS with released 6-TG drug were thawed, filtered through a polytetrafluoroethylene (PTFE) syringe filter with pore size 0.22 m and analyzed by an HPLC method with UV detection at wavelength 254 nm, to determine molar concentration of released 6-TG drug in solution.

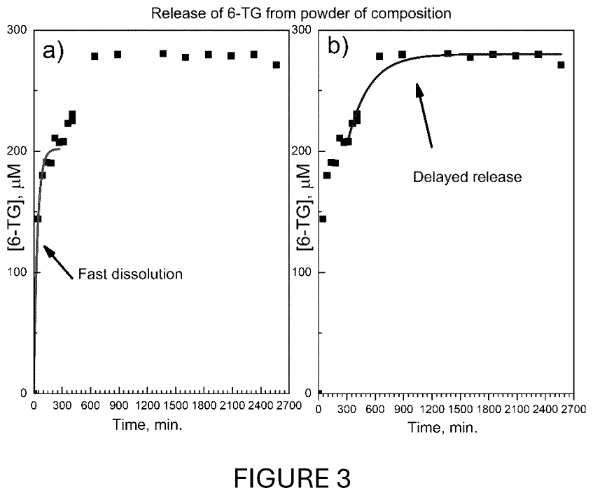

The release profile and kinetics of delayed drug release from composition “6-TG/DUT-4” described above is shown in FIG. 3.

Namely, FIG. 3 shows temporal profile of release of 6-TG drug from composition “6-TG/DUT-4.” The X axis is time in minutes, and the Y axis is the molar concentration of released 6-TG drug in PBS, in micromole/L. The profile in FIG. 3a shows that the dissolution of 6-TG proceeded rather quickly in the first 300 min. and followed kinetics of the pseudo-first order rate law with a rate constant k₁(6-TGCompEarly)=0.026 min⁻¹. Then the rate of dissolution changes, and dissolution proceeded much slower as shown in FIG. 3b in the time scale of about 300-1000 min, with kinetics of the pseudo-first order rate law with a rate constant k₂(6-TGCompLate)=0.004 min⁻¹. This means that delayed release of 6-TG drug occurred about 6 times slower. Finally, in the time period 1000-2700 min. the concentration of released 6-TG remained constant.

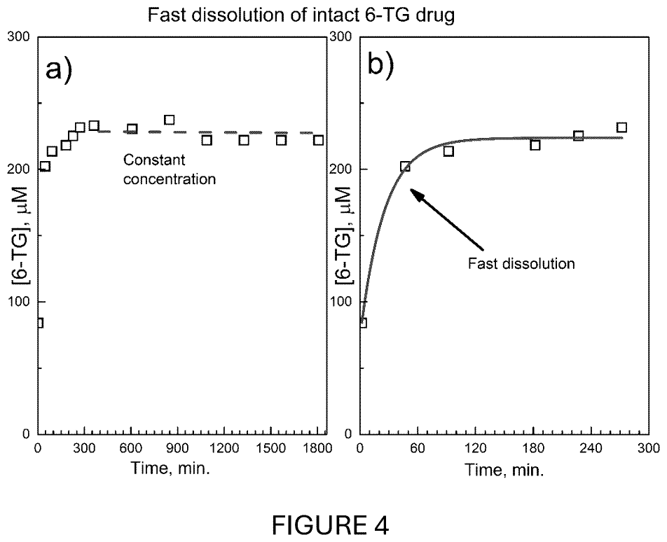

FIG. 4 shows data of the first reference experiment, namely the temporal profile of release of pure intact 6-TG drug which has not been processed by LAG. The X axis is time in minutes, and the Y axis is molar concentration of dissolved 6-TG drug in PBS in micromole/L. In FIG. 4, the concentration of dissolved 6-TG in PBS increased only in the first 300 min., and then reached a plateau. In the first 300 min., the dissolution of pure 6-TG drug followed kinetics of the pseudo-first order rate law with rate constant k(6-TG)=0.040 min⁻¹. Comparison of this rate constant with rate constant k₁(6-TGCompEarly)=0.026 min⁻¹ in FIG. 3 for composition “6-TG/DUT-4” prepared by LAG with pre-mixing allowed one to conclude that these rates are close to each other, and also the dissolution at this kinetic rate occurred in the same time period of 0-300 min. Therefore, in FIG. 3 the rate constant k₁(6-TGCompEarly)=0.026 min⁻¹ for composition “6-TG/DUT-4” prepared with pre-mixing corresponds to dissolution of that fraction of 6-TG in the specimen, which was present in the free form (not bonded to DUT-4 support). In FIG. 3, the second rate constant k₂(6-TGCompLate)=0.004 min⁻¹ for composition “6-TG/DUT-4” corresponded to delayed release of certain fraction of 6-TG drug in the specimen which was chemically bonded to DUT-4 as the support material.

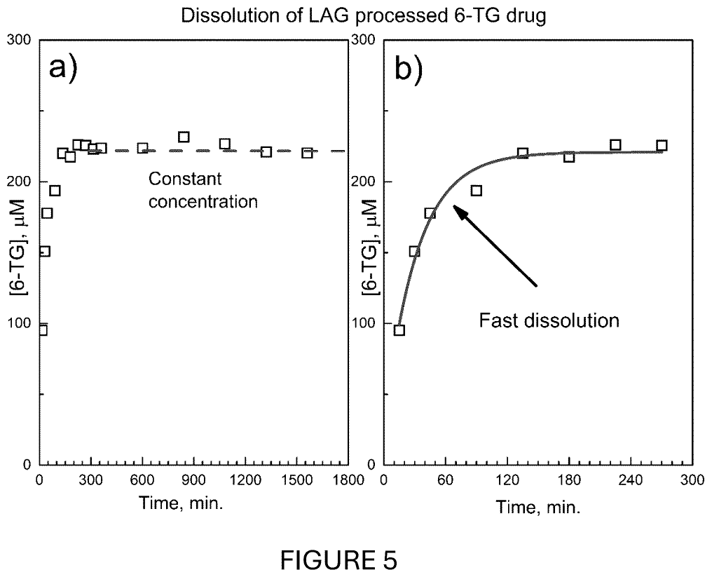

FIG. 5 shows data of the second reference experiment, namely the temporal profile of release of 6-TG that was processed by the same LAG procedure as composition “6-TG/DUT-4”, except that no pre-mixing was conducted since only pure substance was processed. The temporal profile of release of 6-TG was very similar in FIG. 4 and FIG. 5. In FIG. 5, the concentration of dissolved 6-TG in PBS increased only in the first 300 min. and then reached a plateau, and in the first 300 min., dissolution followed kinetics of the pseudo-first order rate law with a rate constant k(6-TGLAG)=0.032 min⁻¹. This value is close to k(6-TG)=0.040 min⁻¹ in FIG. 4. Therefore, in FIG. 4 and in FIG. 5, the obtained curve corresponds only to dissolution of free 6-TG drug. Therefore, in FIG. 3 the second rate constant k₂(6-TGCompLate)=0.004 min¹ for composition 6-TG/DUT-4 corresponds to a delayed release of certain fraction of 6-TG drug in the specimen which was chemically bonded to DUT-4 as the support material.

### Example 2. Preparation of a Pharmaceutical Composition of Gem with Al-MOF-TCPPH₂

In this second non-limiting example according to the invention, a pharmaceutical composition using the drug Gem was prepared. As with Example 1, it is emphasized that the selection of drug for this example was made due to its ready availability and is not intended to limit the invention to the preparation of any particular drug, as it is envisioned that the method of the invention may be used to prepare a pharmaceutical composition with any drug or active ingredient.

In this Example 2, Al-MOF-TCPPH₂ support material prepared according to G.-A. Banga-Bothy, et al., Porphyrin aluminum MOF with ultra-high water sorption capacity: In-situ time-dependent ATR-FTIR spectroscopy and gravimetry to study mechanism of water bonding and desorption, Vib. Spectrosc. 119 (2022) Article 103356, was thermally treated at 200° C. in a vacuum oven for 21 h. under vacuum of rotary vane oil pump, to remove impurities and “activate,” which means preparing Al-MOF-TCPPH₂ for the interaction with Gem drug. Then, working in a glove bag filled with dried air, a 0.25 mmol Gem was pre-mixed with 0.25 mmol activated Al-MOF-TCPPH₂ in a 5 ml stainless steel grinding vessel. The vessel was closed tightly with a stainless-steel cap, and the assembly was placed into mechanical ball mill Retsch MM 301 and shaken at 30 Hz frequency for 30 min in a pre-mixing step.

After mechanical pre-mixing, the grinding vessel was opened in a glove bag filled with dried air, and 0.25 ml of isopropanol (grinding fluid) was added to the obtained dry mixture of powders. Then a grinding element (one stainless steel ball 7 mm in diameter) was added, and the grinding vessel was closed with the cap.

Then, the LAG was conducted to obtain composition “Gem/Al-MOF-TCPPH₂” and the obtained composition was dried and tests of delayed release of drug were conducted per the procedures described above.

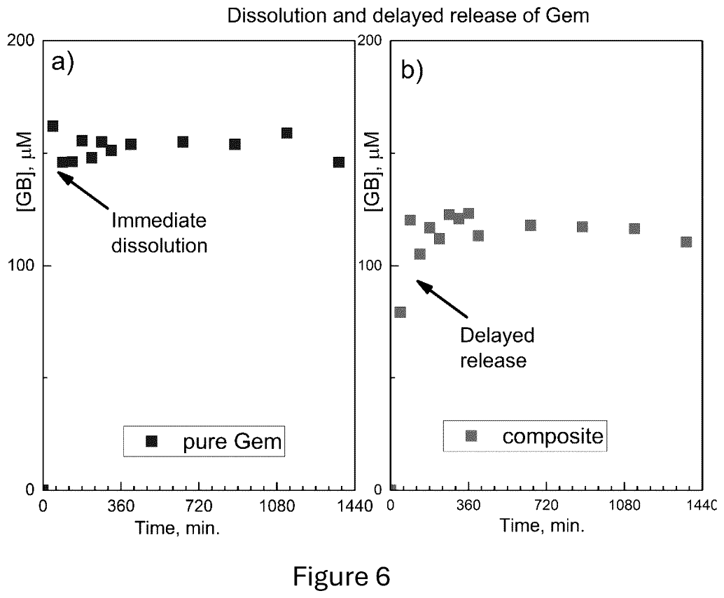

FIG. 6a shows the temporal profile of dissolution of pure Gem drug (the reference experiment) and FIG. 6b shows the same for Gem released from composition “Gem/Al-MOF-TCPPH₂”. The X axis is time in minutes, and the Y axis is molar concentration of Gem drug (denoted in FIG. 6 as GB) in PBS, in micromole/L. The profile in FIG. 6a shows that dissolution of pure Gem occurred very quickly in less than 15 min. and its kinetic rate constant cannot be determined. In contrast, in FIG. 6b, there is delayed release of Gem from the composition up to 300 min., and then its concentration remained constant.

The present invention is directed to a method for preparation of pharmaceutical compositions with improved homogeneity and is effective for the formulation of any type of drug or other active ingredient. The detailed description and examples herein should not be construed to limit the invention to any particular drug or to any particular support material.

1. A method for preparing a pharmaceutical composition or precursor thereto comprising mechanical pre-mixing a powdered drug and a powdered inert support material in a grinding vessel, subsequently adding a grinding fluid to said dry powdered mixture to produce a wetted mixture, followed by adding a grinding element to said wetted mixture, and carrying out a liquid assisted grinding step with said wetted mixture and said grinding element to produce a co-ground wetted mixture.

2. The method of claim 1, further comprising drying said co-ground wetted mixture.

3. The method of claim 2, wherein said drying step takes place in air, in inert gas, or under vacuum.

4. The method of claim 3, wherein said inert gas is nitrogen or argon or other noble or chemically non-reactive gas.

5. The method according to claim 1, wherein the support material is a metal-organic framework.

6. The method according to claim 1, wherein the drug comprises two or more active ingredients.

7. The method according to claim 1, wherein the support material comprises two or more components.

8. A pharmaceutical composition prepared according to claim 1.

9. The pharmaceutical composition of claim 8, wherein said pharmaceutical composition exhibits delayed or accelerated in-vitro drug release to a physiological fluid or into live cells in media.

10. The pharmaceutical composition of claim 8, wherein said pharmaceutical composition exhibits delayed or accelerated release of said drug upon administration to a subject.

11. A drug releasing device comprising the pharmaceutical composition of claim 8.
